(19) United States
(12) Patent Application Publication
(10) Pub. No.: US 2013/0097317 A1
(43) Pub. Date: Apr. 18, 2013

(54) METHOD AND APPARATUS FOR REMOTE TRUST MANAGEMENT FOR MACHINE TO MACHINE COMMUNICATIONS IN A NETWORK

(71) Applicants: DANIEL SHELEHEDA, Florham Park, NJ (US); Donald J. Bowen, Madison, NJ (US); Cynthia Cama, Belmar, NJ (US); Lusheng Ji, Randolph, NJ (US)

(72) Inventors: DANIEL SHELEHEDA, Florham Park, NJ (US); Donald J. Bowen, Madison, NJ (US); Cynthia Cama, Belmar, NJ (US); Lusheng Ji, Randolph, NJ (US)

(21) Appl. No.: 13/276,114

(22) Filed: Oct. 18, 2011

(51) Int. Cl. H04W 48/00

(52) U.S. Cl. 709/225

(57) ABSTRACT

A method, non-transitory computer readable medium and apparatus for providing remote trust management for machine to machine communications in a network are disclosed. For example, the method receives a request from a sensor to join a wireless network, determines a trust score of the sensor by a server at the network, and allows the sensor to join the wireless network if the trust score is greater than a predetermined threshold.

The present disclosure relates generally to machine to machine communications and, more particularly, to a method and apparatus for remote trust management for machine to machine communications in a network.

### BACKGROUND

Machine to machine (M2M) and wireless sensor networks have emerged and are expected to continue to expand into almost every aspect of our lives. Currently, M2M and wireless sensor networks have some level of security. However, to add new devices to the M2M and wireless sensor networks requires on-site technicians. For example, a service provider must send a person to the customer site to install and configure the new device manually. This is inefficient in terms of time and costs to the service provider. In addition, since there is no recovery process, if the initial configuration is lost or corrupted, then the technician must return to the customer site.

### SUMMARY

In one embodiment, the present disclosure provides a method, non-transitory computer readable medium and apparatus for providing remote trust management in a network. For example, the method receives a request from a sensor to join a wireless network, determines a trust score of the sensor by a server at the network, and allows the sensor to join the wireless network if the trust score is greater than a predetermined threshold.

### BRIEF DESCRIPTION OF THE DRAWINGS

The teaching of the present disclosure can be readily understood by considering the following detailed description in conjunction with the accompanying drawings, in which:

FIG. 1 illustrates one example of a communications network of the present disclosure;

FIG. 2 illustrates an example flowchart of one embodiment of a method for providing remote trust management for machine to machine communications in a communication network; and

FIG. 3 illustrates a high-level block diagram of a general-purpose computer suitable for use in performing the functions described herein.

To facilitate understanding, identical reference numerals have been used, where possible, to designate identical elements that are common to the figures.

### DETAILED DESCRIPTION

The present disclosure broadly discloses a method, non-transitory computer readable medium and apparatus for providing remote trust management for machine to machine communications in a network. Machine to machine (M2M) and wireless sensor networks have emerged and are expected to continue to expand into almost every aspect of our lives. M2M and wireless sensor networks support a variety of home and office automation, security monitoring, smart energy deployment and manufacturing applications. It should be noted that this is not an exhaustive list.

M2M and wireless sensor networks typically comprise of low cost, low power wireless networks that use small microcontroller devices, such as for example, intelligent sensors, to monitor and control aspects of the application environment. Various types of communication protocols may be used in M2M and wireless sensor networks.

Because such devices lack a general purpose user interface that is friendly to average users, such as a keyboard and a screen, to add new devices to the M2M and wireless sensor networks typically requires the use of special equipment and on-site technicians. For example, a service provider must send a person to the customer site to install and configure the new device manually. Typically, the technician presses small buttons on the device a predetermined number of times and/or sets dip switches. This is inefficient in terms of time and costs to the service provider. In addition, since there is no recovery process, if the initial configuration is lost or corrupted, then the technician must return to the customer site.

M2M and wireless sensor networks may have some level of security, such as for example, data encryption and message integrity. However, novel methods for managing what devices can be trusted to join these networks and for remotely configuring these devices will be beneficial. The present disclosure discloses an efficient remote trust management system that has remote configuration and deployment abilities that do not require on site technicians to be deployed.

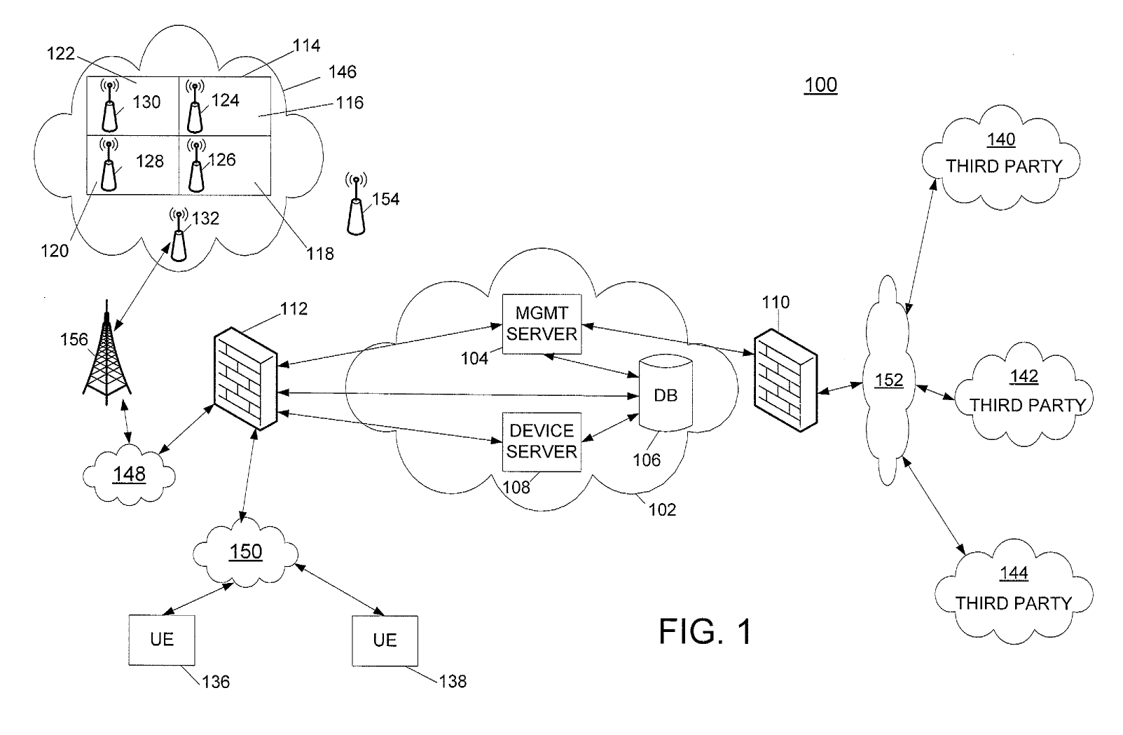

FIG. 1 is a block diagram depicting one example of a communications network 100. The communications network 100 may be any type of Internet Protocol (IP) network such as an IP Multimedia Subsystem (IMS) network, a wireless network, a broadband cellular data network, a long term evolution (LTE) network, and the like, related to the current disclosure. It should be noted that an IP network is broadly defined as a network that uses IP to exchange data packets. Additional exemplary IP networks include Voice over Internet Protocol (VoIP) networks, Service over Internet Protocol (SoIP) networks, and the like. The present disclosure is not limited to any particular network architecture.

In one embodiment, the network 100 may comprise a core network 102. The core network 102 may be in communication with one or more access networks 148, 150 and 152. The access networks 148, 150 and 152 may include a wireless access network, a cellular access network, a Public Switched Telephone Network (PSTN) access network, a cable access network, a wired access network and the like. In one embodiment, the access networks 148, 150 and 152 may all be different types of access networks, may all be the same type of access network or some access networks may be the same type of access network and others may be different types of access networks. The core network 102 and the access networks 148, 150 and 152 may be operated by different service providers, the same service provider or a combination thereof. In one embodiment, a firewall 112 may be included between the core network 102 and the access networks 148 and 150. In one embodiment, a firewall 110 may be included between the core network 102 and the access network 152.

In one embodiment, the access network 150 may be in communication with one or more user endpoints (also referred to as “endpoints” or “UEs”) 136 and 138. The endpoints 136 and 138 may be any type of endpoint device including but not limited to, for example, a smart phone, a cellular telephone, a laptop, a tablet device, a desktop computer, a web enabled television, and the like.

In one embodiment, the access network 148 may be in communication with one or more wireless networks 146. In one embodiment, the wireless network 146 may be a personal area network or local area network. The wireless network 146 may use any type of communications protocol for enabling communications between the devices deployed within the wireless network 146. For example, the devices within the wireless network 146 may communicate using a ZigBee® protocol, a Bluetooth® protocol, an ANT® protocol, a Z-Wave protocol and the like.

In one embodiment, the wireless network 146 or portions thereof may operate within a customer premise 114. For example, the customer premise may be a home or a business location. Within the customer premise 114, there may be one or more locations 116, 118, 120 and 122. In one embodiment, the one or more locations 116, 118, 120 and 122 may be different rooms or different areas within the customer premise 114. Some of the locations 116, 118, 120 or 122 may also be outside the customer premise 114, for example, around the yard of the customer premise 114. Although FIG. 1 illustrates a single customer premise 114 and four locations 116, 118, 120 or 122, it should be noted that any number customer premises and locations may be used.

In one embodiment, each one of the locations 116, 118, 120 and 122 may have a respective sensor 124, 126, 128 and 130 (broadly previously authenticated sensors). It should be noted that a sensor may be defined as a simple device where its primary function is to determine whether some event has occurred, i.e., the sensor is specifically tasked to detect the occurrence of the event. For example, the sensor may be a security sensor that is deployed to detect whether a door is open, whether a window is open, whether an intruder is detected, whether motion of an object is detected within an area, whether a leak is detected, whether some item in a refrigerator has run out and the like. Notably, the sensors used herein are not intended to encompass computers with graphical user interfaces. In one embodiment, the sensors 124, 126, 128 and 130 may be deployed as a stand-alone device or as part of an appliance or other apparatus. The sensors 124, 126, 128 and 130 may be used in machines that use M2M communications.

In one embodiment, the wireless network 146 also includes a coordinator sensor 132. The coordinator sensor 132 communicates with all of the other sensors 124, 126, 128 and 130 at the customer premise 114. In one embodiment, the coordinator sensor 132 may further have the ability to communicate with a gateway 156 to communicate over the access network 148 with the core network 102.

In one embodiment, the access network 152 may be in communication with one or more third parties 140, 142 and 144. The third parties 140, 142 and 144 may include, for example, installers of the sensors 124, 126, 128 and 130, manufacturers of the sensors 124, 126, 128 and 130 or other partners, such as for example, alarm companies that may use or sell the sensors 124, 126, 128 and 130 to their customers as parts of an integrated system.

In one embodiment, the core network 102 may include a management (MGMT) server 104, a database (DB) 106 and a device server 108. In one embodiment, the management server 104 may be responsible for remotely configuring the sensors 124, 126, 128 and 130 and for granting access to a new sensor, e.g., a sensor 154. In addition, the management server 104 may be responsible for sending notifications to a subscriber's endpoint device 136 or 138.

In one embodiment, the database 106 may store information about each one of the sensors 124, 126, 128 and 130. For example, the information may include information such as a sensor's media access control (MAC) address, the type of technology supported, the type of communication protocols supported, historical information such as when and where the sensor has been previously manufactured, purchased, installed, and the like. All of this information may contribute to a trust score.

In one embodiment, the database 106 may also store configuration data about the sensors 124, 126, 128 and 130. As a result, if the configuration data of any sensors within the wireless network 146 become corrupted or lost, the sensors may be remotely configured using the configuration data stored in the database 106. In one embodiment, configuration information may include an identification (ID) of the wireless network 146 that the sensor is associated with, an encryption key, a network address of the coordinator sensor 132 and the like.

In one embodiment, the device server 108 may collect data from the sensors 124, 126, 128 and 130. The data may then be stored in the database 106. The collected data may include, for example, when a particular sensor is triggered, a date and time stamp, topology information of the wireless network 146 and the like.

Although only a single management server 104, a single database 106 and a single device server 108 are illustrated, it should be noted that more than one management server, database and device server may be deployed. In addition, although the management server 104, the database 106 and the device server 108 are illustrated as all being in the core network 102, it should be noted that one or more of the management server 104, the database 106 or the device server 108 may be remotely located from one another, e.g., in one of the access networks 148, 150 or 152, or even at a third party site.

In one embodiment, the network 100 illustrated by FIG. 1 provides remote trust management for M2M communications. In one embodiment, remote trust management may be provided by registering and storing sensor trust parameters with a service provider of the of the communication network 102. The sensor trust parameters may include various sensor information, conditions for activation (e.g., a time window, ID's of other network elements), and the like.

For example, a third party manufacturer 140 of the sensors 124, 126, 128, 130 and 154 may elect to cooperate with a service provider of the core network 102 to allow for remote trust management for M2M communications. As a result, the third party 140 may register information of the sensors 124, 126, 128, 130 and 154 with the service provider of the network 102. As discussed above, the information may include a sensor's MAC address, the type of technology supported, the type of communication protocols supported, historical information such as when and where the sensor has been previously manufactured, sold, and/or installed, its configuration settings, and the like. This information may then be stored in the database 106.

Once the sensor information is registered and stored, the third party 140 may distribute the sensors 124, 126, 128, 130 and 154 for sale either through the service provider of the network 102 or through retail stores. Thus, when a subscriber purchases a new sensor, e.g., 154, the subscriber may have the sensor remotely added and configured to the wireless network 146.

In one embodiment, if the new sensor 154 is purchased from the service provider of the network 102, the service provider may provide instructions to the subscriber as to a window of time (e.g., a day and time, e.g., on Tuesday between 1:00 PM and 2:00 PM), when the new sensor 154 should be activated. Accordingly, the service provider may update the database 106 for the new sensor 154 that a request for activation and configuration may come at the specified time and day.

When the subscriber receives the new sensor 154, the subscriber may simply activate the new sensor 154 at the specified date and time window. The new sensor 154 may automatically communicate with the coordinator sensor 132 to request activation and configuration for the wireless network 146. The request may include information about the new sensor 154 such as the MAC address of the new sensor. The coordinator sensor 132 may then relay the request to the gateway 156 and add additional information to the request, such as for example, the MAC address of the coordinator sensor 132, an ID of the wireless network 146 and the like. The gateway 156 may then relay the request to the management server 104.

In one embodiment, new sensors (e.g., the new sensor 154) may communicate with the coordinator sensors 132 and/or the management server 104 to discover and attempt to connect to possible candidate wireless networks. During this process, the coordinator sensors 132 and/or the management server 104 may exchange only trust management traffic with the new sensor before the sensor formally requests to join a candidate wireless network using the process described herein.

In one embodiment, the management server 104 may then calculate a trust score to determine if the trust score is greater than a predetermined trust score for the new sensor 154. In one embodiment, the trust score may require some or all of the predefined requirements to be met. For example, if there are at least four parameters that need to be met, the new sensor 154 may get one point for each requirement met and, thus, need a predetermined trust score of four to be trusted.

To illustrate, using the above example, for the new sensor 154 to be trusted, the request must be received at the specified window of time and day provided by the service provider, the request must have a MAC address associated with the coordinator sensor 132 of the subscriber, the new sensor 154 must have never been installed at a previous location, and a confirmation that an request has been previously received from that particular subscriber as to the installation of a new sensor. It should be noted that this is only an example.

In one embodiment, by ensuring that the coordinator sensor 132 relayed the request from the new sensor 154, it will prevent a neighbor or other party from attempting to “hack” into the wireless network 146 with a rouge sensor. In addition, when a request is received to add a new sensor, the management server 104 may send a notification to an endpoint of the subscriber, e.g., the endpoint 136. In one embodiment, the notification may include a request that the subscriber confirms that he or she is the one trying to add the new sensor 154. This also prevents a malicious hacker from attempting to add a new sensor 154 to the subscriber's wireless network. In one embodiment, the notification may be, for example, an email, a text message or a telephone call. In one embodiment, the management server 104 may wait to proceed until a confirmation is received from the subscriber that the subscriber activated the sensor 154 to join the wireless network 146.

Thus, in the above example, the predetermined trust score may be “4” and the trust score must be greater than “4” for validation. In other words, if all four requirements are met with the request, then the management server 104 may assign 1 point to each met requirement for a total score of “4”. As a result, the trust score would be greater than the predetermined trust score and the new sensor 154 would be granted access to join the wireless network 146 and remotely configured by the device server 108.

In another embodiment, the predetermined trust score may simply comprise a binary value. For example, a “1” is assigned to the sensor if the sensor is listed on an access control list that includes all sensors that were deemed to be trusted, or a “0” if the sensor is not on the access control list. As a result, the trust score must be greater than 0 to be a trusted sensor.

Thus, the management server 104 may look up the new sensor's MAC address to see if it is listed in the access control list. If the new sensor 154 is on the access control list, then the trust score of the new sensor 154 may be assigned a value of “1,” which is greater than the predetermined trust score of “0” and be granted access to join the wireless network 146. In one embodiment, the access control list may be created using the sensor parameters discussed above.

It should be noted that the above are only a few examples of how to use a “trust score”. Other methods pertaining to how trust scores can be calculated are within the scope of the present disclosure.

In another embodiment, the new sensor 154 may be purchased from a retail store. As a result, the subscriber may either call a 1-800 number (toll free number) or log into a web site operated by the service provider to provide information about the purchased sensor 154. Once the service provider obtains the information from the subscriber about the new sensor 154, the service provider may then provide information about a window of time as to when the new sensor 154 should be activated. Subsequently, any one of the illustrative methods described above may be used to remotely determine whether the new sensor 154 should be trusted and remotely configured to join the wireless network 146.

As a result, when a subscriber attempts to add a new sensor to the wireless network 146, the service provider does not need to send a technician on-site to manually configure the new sensor. Rather, the new sensor 154 may be remotely authenticated and configured as a trusted sensor to join the wireless network 146.

It should be noted that the network 100 has been simplified. For example, the network 100 may include other network elements (not shown) such as border elements, routers, switches, call control elements, policy servers, security devices, a content distribution network (CDN) and the like.

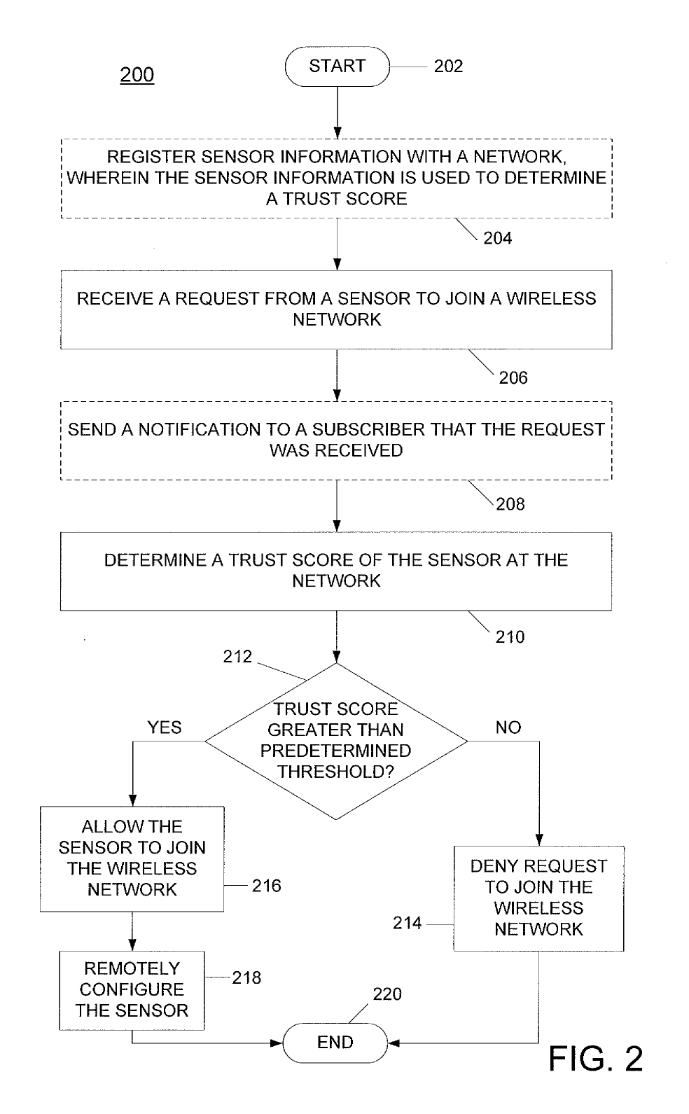

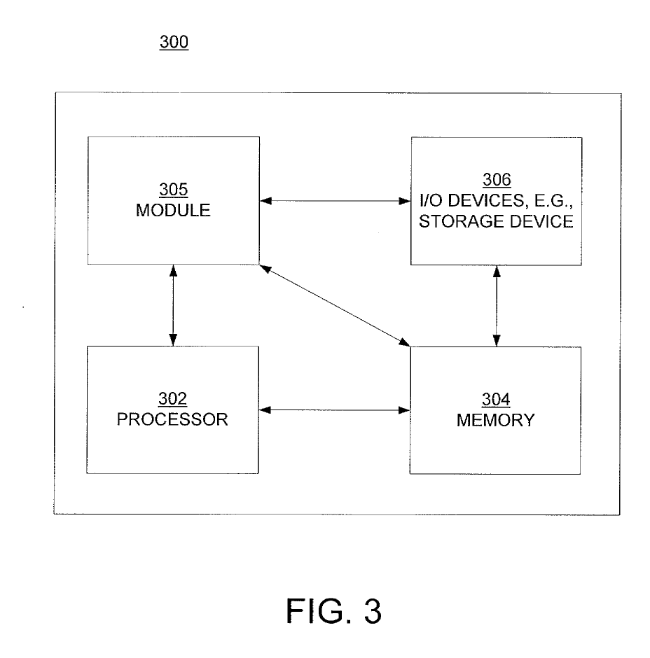

FIG. 2 illustrates a flowchart of a method 200 for providing remote trust management for machine to machine communications in a network. In one embodiment, the method 200 may be performed by the management server 104 or a general purpose computer as illustrated in FIG. 3 and discussed below.

The method 200 begins at step 202. At optional step 204, the method 200 registers sensor information with a network, wherein the sensor information is used to determine a trust score. As discussed above, a third party manufacturer, installer or alarm company, may register information associated with a sensor that will be installed or sold. As discussed above, the sensor information may include a sensor's media access control (MAC) address, the type of technology supported, the type of communication protocols supported, historical information such as when and where the sensor has been previously manufactured, sold, installed, and the like. The information may then be stored in a database in the network and accessed by the management server to calculate the trust score. In addition, the sensor information may include configuration information that may be used to remotely configure the sensor once it is activated and authenticated.

At step 206, the method 200 receives a request from a sensor to join a wireless network. For example, after the sensor information is registered with the network, the sensor may be bought by a subscriber to be added to the subscriber's machine to machine wireless sensor network, for example at the subscriber's home or business location.

The subscriber may activate the new sensor using instructions provided by the service provider, e.g., either by accessing a web site or calling the service provider of the network. The new sensor may then communicate with a coordinator sensor in the wireless network and relay the request to a gateway, which in turns relays the request to the network of the service provider.

In one embodiment, the request may include information needed by the network to calculate a trust score. For example, the information may include a MAC address of the new sensor, a MAC address of the coordinator sensor, a date and time stamp of when the request was made and the like.

At optional step 208, the method 200 may send a notification to a subscriber that the request for joining a new sensor was received. For example, to prevent hackers from adding unauthorized sensors within the subscriber's wireless network, when a request is received by the network to add a new sensor, a notification may be sent to the subscriber. For example, a text message, an email or a telephone call may be sent to an endpoint device of the subscriber registered with the network. The notification may ask for confirmation that the subscriber was the one who activated the new sensor that initiated the request to join the wireless network. In one embodiment, the subscriber may be asked to reply to the notification so that the network may have a record of the confirmation, e.g., a verbal response or a reply email or text message, from the subscriber.

At step 210, the method 200 determines a trust score of the sensor at the network. The trust score may be calculated as discussed above. For example, a score may be attributed to each requirement met for being considered a trusted sensor. As discussed above, there may be various requirements needed to be considered a trusted sensor, e.g., the request must be received at the specified window of time provided by the service provider, the request must be from a MAC address associated with the coordinator sensor of the subscriber, the new sensor must have never been installed at a previous location and a confirmation has been received from the subscriber. It should be noted that any number of predefined requirements can be specified based on the requirements of a particular deployment. Thus, for each requirement that is met, the sensor may be attributed “1 point”. A total amount of “points” may be added together to determine an overall trust score. In another embodiment, the trust score may simply be a binary value with respect to whether or not the sensor is on an access control list.

At step 212, the method 200 determines if the trust score is greater than a predetermined threshold. If the trust score is not greater than the predetermined threshold, the method 200 proceeds to step 214, where the method 200 denies the request to join the wireless network. The method 200 then proceeds to step 220, where the method 200 ends.

However, if at step 212, the method 200 determines that the trust score is greater than the predetermined threshold, then the method 200 proceeds to step 216. At step 216, the method 200 allows the sensor to join the wireless network.

At step 218, the method 200 remotely configures the sensor. For example, the configuration settings and parameters that were registered at step 204 can be obtained from the database and used to properly configure and deploy the sensor in the wireless network. The method 200 then proceeds to step 220, where the method 200 ends.

It should be noted that although not explicitly specified, one or more steps of the method 200 described above may include a storing, displaying and/or outputting step as required for a particular application. In other words, any data, records, fields, and/or intermediate results discussed in the methods can be stored, displayed, and/or outputted to another device as required for a particular application. Furthermore, steps or blocks in FIG. 2 that recite a determining operation, or involve a decision, do not necessarily require that both branches of the determining operation be practiced. In other words, one of the branches of the determining operation can be deemed as an optional step.

FIG. 3 depicts a high-level block diagram of a general-purpose computer suitable for use in performing the functions described herein. As depicted in FIG. 3, the system 300 comprises a processor element 302 (e.g., a CPU), a memory 304, e.g., random access memory (RAM) and/or read only memory (ROM), a module 305 providing remote trust management for machine to machine communications in a network, and various input/output devices 306 (e.g., storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like)).

It should be noted that the present disclosure can be implemented in software and/or in a combination of software and hardware, e.g., using application specific integrated circuits (ASIC), a general purpose computer or any other hardware equivalents, e.g., computer readable instructions pertaining to the method(s) discussed above can be used to configure a hardware processor to perform the steps of the above disclosed method. In one embodiment, the present module or process 305 for providing remote trust management for machine to machine communications in a network can be loaded into memory 304 and executed by hardware processor 302 to implement the functions as discussed above. As such, the present module or process 305 for providing remote trust management for machine to machine communications in a network (including associated data structures) of the present disclosure can be stored on a non-transitory (physical and tangible) computer readable storage medium, e.g., RAM memory, magnetic or optical drive or diskette and the like.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method for providing remote trust management in a network, comprising:
receiving a request from a sensor to join a wireless network;
determining a trust score of the sensor by a server at the network; and
allowing the sensor to join the wireless network if the trust score is greater than a predetermined threshold.

2. The method of claim 1, wherein the wireless network comprises a personal area network.

3. The method of claim 2, wherein the wireless network uses a ZigBee communications protocol.

4. The method of claim 1, wherein the sensor comprises a security sensor.

5. The method of claim 1, further comprising:
registering sensor trust parameters with the network, wherein the sensor trust parameters are used to determine the trust score.

6. The method of claim 5, wherein the sensor trust parameters are stored in a database in the network.

7. The method of claim 5, wherein the sensor trust parameters include configuration settings for the sensor, wherein the configuration settings are used to remotely configure the sensor if a configuration of the sensor is corrupted.

8. The method of claim 5, wherein the registering is performed by a third party manufacturer of the sensor.

9. The method of claim 1, further comprising:
sending a notification to a subscriber that the request was received; and
receiving confirmation that the subscriber activated the sensor to join the wireless network.

10. The method of claim 1, wherein the request is received from a gateway of the wireless network comprising a plurality of authenticated sensors and a coordinator sensor.

11. The method of claim 1, further comprising:
configuring the sensor remotely via the server of the network.

12. A non-transitory computer-readable medium having stored thereon a plurality of instructions, the plurality of instructions including instructions which, when executed by a processor, cause the processor to perform a method for providing remote trust management in a network, comprising:
receiving a request from a sensor to join a wireless network;
determining a trust score of the sensor by a server at the network; and
allowing the sensor to join the wireless network if the trust score is greater than a predetermined threshold.

13. The non-transitory computer-readable medium of claim 12, wherein the wireless network comprises a personal area network.

14. The non-transitory computer-readable medium of claim 13, wherein the wireless network uses a ZigBee communications protocol.

15. The non-transitory computer-readable medium of claim 12, further comprising:
registering sensor trust parameters with the network, wherein the sensor trust parameters are used to determine the trust score.

16. The non-transitory computer-readable medium of claim 15, wherein the sensor trust parameters are stored in a database in the network.

17. The non-transitory computer-readable medium of claim 15, wherein the sensor trust parameters include configuration settings for the sensor, wherein the configuration settings are used to remotely configure the sensor if a configuration of the sensor is corrupted.

18. The non-transitory computer-readable medium of claim 12, further comprising:
sending a notification to a subscriber that the request was received; and
receiving confirmation that the subscriber activated the sensor to join the wireless network.

19. The non-transitory computer-readable medium of claim 12, further comprising:
configuring the sensor remotely via the server at the network.

20. An apparatus for providing remote trust management in a network, comprising:
a processor deployed at the network configured to:
receive a request from a sensor to join a wireless network;
determine a trust score of the sensor; and
allow the sensor to join the wireless network if the trust score is greater than a predetermined threshold.
